(19) United States
(12) Patent Application Publication
(10) Pub. No.: US 2020/0309578 A1
(43) Pub. Date: Oct. 1, 2020

(54) ELECTROMAGNETIC FLOW METER

(71) Applicant: Apator Miitors ApS, Aarhus V (DK)

(72) Inventor: Jens Drachmann, Viby J (DK)

(73) Assignee: Apator Miitors ApS, Aarhus V (DK)

(21) Appl. No.: 16/626,145

(22) PCT Filed: Jul. 7, 2017
(86) PCT No.: PCT/DK2017/050232

§ 371 Date: Dec. 23, 2019

(51) Int. Cl. G01F 1/58; G01F 1/60

(52) U.S. Cl. CPC G01F 1/586; G01F 1/584; G01F 1/60

(57) ABSTRACT

An electromagnetic transmitter unit for an electromagnetic flow meter arranged to measure a flow rate of a conductive fluid flowing through the flow meter, is disclosed. The transmitter unit comprises a capacitive energy storage comprising at least one capacitor, a magnetic field coil and a switching arrangement. The switching arrangement is configured for effecting a first energy flow from the capacitive energy storage to the magnetic field coil and a first energy reflow from the magnetic field coil to the capacitive energy storage for generation of a first current pulse for transmitting a magnetic field to the conductive fluid. An electromagnetic flow meter is also disclosed, comprising the electromagnetic transmitter unit together with a detector unit and a control unit. Further is a method for controlling an electromagnetic flow meter disclosed.

### FIELD OF THE INVENTION

The invention relates to electromagnetic transmitter units, an electromagnetic flow meter having an electromagnetic transmitter unit, and a method for measuring a flow rate using an electromagnetic flow meter.

### BACKGROUND OF THE INVENTION

Electromagnetic flow meters are often used to measure the volume of water used by residential and commercial buildings that are supplied with water by a public or private water supply system.

Electromagnetic flow meters use Faraday's law of electromagnetic induction, which states that a voltage will be induced in a conductor moving through a magnetic field. The liquid serves as the conductor; the magnetic field is created by energized coils and the induced voltage is measured with pickup electrodes.

Faraday's law states U=k*B*D*V where V in the equation is the velocity of a conductive fluid, B is the magnetic field strength, D is the spacing between the pickup electrodes, U is the voltage measured across the electrodes, and k is a constant. B, D, and k are either fixed values or can be calibrated.

Consequently, the equation may be reduced to the velocity of the conductive fluid V being directly proportional with the measured voltage across the electrodes U.

A volume of fluid flow may be measured with an electromagnetic flow meter by measuring the velocity of fluid over a known area such as the cross-section area of a pipe or tube wherein the fluid flows, as generally shown in FIG. 1.

Early versions of electromagnetic flow meters use a DC current excitation for creating the magnetic field. More advanced and modern versions use different forms of time modulated constant excitation currents to overcome noise problems and save energy consumption.

A modern electromagnetic flow meter is often electric battery driven to avoid connection of an external energy source and give the necessary versatility to install the flow meter in any relevant location of a building. International patent application publication no. 2006/02921 discloses a known example of an electric battery driven flow meter operating with a less frequent modulation of the current excitation for creating the magnetic field. The less frequent modulation is used in order to reduce the energy consumption from the electric battery by the electric circuits in the flow meter.

However, battery operated flow meters are supposed to operate for many years such as up to 10 years—especially water meters—and it is necessary to optimize the electric circuit even more, so that energy is conserved and smaller batteries can be used, longer lifetime can be obtained—or more frequent measurements can be made.

It is an object of the invention to provide an electromagnetic flow meter with an improved functionality in the electric circuits.

### SUMMARY OF THE INVENTION

The inventor has identified the above-mentioned problems and challenges related to electromagnetic flow meters, and subsequently made the below-described invention which may improve the functionality in the electric circuits.

In an aspect, the invention relates to an electromagnetic transmitter unit for an electromagnetic flow meter arranged to measure a flow rate of a conductive fluid flowing through the flow meter, said transmitter unit comprises: a capacitive energy storage comprising at least one capacitor, a magnetic field coil, and a switching arrangement; wherein the switching arrangement is configured for effecting a first energy flow from the capacitive energy storage to the magnetic field coil and a first energy reflow from the magnetic field coil to the capacitive energy storage for generation of a first current pulse for transmitting a magnetic field to the conductive fluid.

Hereby is obtained an electromagnetic transmitter unit for an electromagnetic flow meter, with an improved functionality by conserving energy consumption and regeneration of electric charge by controlling energy flow in an LC (quasi resonant) circuit. The control of energy flow allows smaller batteries to be used in the low power flow meter and with a longer operational time.

A further advantage is that the magnetic field polarities can be switched often, or the magnetic field otherwise modulated, without additional energy consumption, thereby enabling suppression of offset and drift errors.

A capacitive energy storage refers to an energy storage comprising at least one capacitor, such as for example just one capacitor, two capacitors, several capacitors, a combination of one or more capacitors with one or more batteries, etc. The at least one capacitor of the capacitive energy storage may be a discrete or integrated capacitor component, or may be an intrinsic capacitance of another component.

The magnetic field coil may be one or more coils equivalent to one coil from an electric circuit perspective.

In an advantageous embodiment, the switching arrangement is further configured for effecting a second energy flow and a second energy reflow between the capacitive energy storage and the magnetic field coil for generation of a second current pulse for transmitting a magnetic field to the conductive fluid.

In an advantageous embodiment, the current of the second current pulse is smaller than the current of the first current pulse.

A current of the second current pulse being smaller than the current of the first current pulse refers to the peak current during the pulse, or the integrated current during the pulse, being smaller in the second pulse than in the first pulse. This is advantageous as it allows repeated establishment of a magnetic field for further measurements, at least one further measurement, without recharging the energy storage, e.g. first capacitor, thereby achieving less energy loss. A series of current pulses will preferably have decreasing current peak levels or integrated current, the series consisting of at least two current pulses within a time period. After a certain time period, after a certain number of pulses, or when the current pulse peak level or current pulse start voltage gets below a certain threshold, the capacitive energy storage, e.g. capacitor, is preferably recharged to initialize a new series of decreasing current pulses.

Preferably, the magnetic field coil generates the magnetic field as series of different sized/non-constant pulses within a time period in response to the change of the energy flow. Preferably, the time period is the time between two successive energizations of the capacitive energy storage from an electric energy source.

In an advantageous embodiment, the second energy flow and second energy reflow is more than 80% of the first energy flow and first energy reflow.

In a preferred embodiment, the energy loss for each pulse generation is less than 20%, for example less than 15% or less than 10%.

In an advantageous embodiment, the capacitive energy storage comprises a first capacitor, and wherein the switching arrangement is configured for effecting the first energy flow from the first capacitor to the magnetic field coil and the first energy reflow from the magnetic field coil to the first capacitor.

A simple and advantageous circuit is achieved when the energy is simply sent back and forth between a capacitor and a coil.

In an advantageous embodiment, the capacitive energy storage comprises a first capacitor and a second capacitor, and wherein the switching arrangement is configured for effecting the first energy flow from the first capacitor to the magnetic field coil and the first energy reflow from the magnetic field coil to the second capacitor.

A simple and advantageous circuit is achieved when the energy is sent back and forth between two capacitor through the coil, using the flywheel characteristic of the coil to move charge between the capacitors beyond the point of equilibrium.

In an advantageous embodiment, the switching arrangement is configured for effecting the second energy flow from the second capacitor to the magnetic field coil and the second energy reflow from the magnetic field coil to the first capacitor.

In an advantageous embodiment, the first capacitor and the second capacitor are of the same type and value.

Hereby is achieved a simple and symmetrical circuit configuration, with optimized energy preservation, as capacitance and charging/discharging curves will be substantially identical, thereby reducing loss.

In an advantageous embodiment, the magnetic field coil is voltage driven by the capacitive energy storage.

The advantageous use of a capacitive energy storage, e.g. one or two capacitors, and driving the magnetic field coil in a voltage driven configuration, achieves high energy efficiency, and the capacitive energy storage is less sensitive to external magnetic fields. Compared to solutions with permanent magnets or relying on magnetic remanence, the modulation or switching of the magnetic field can be performed much more energy efficiently with the capacitive energy storage and voltage driven magnetic field coil.

In an advantageous embodiment, the first current pulse is a first time-dependent current pulse.

By time-dependent current pulse is referred to a development of current where the current value varies continuously over time between two instances of zero current. A time-dependent current pulse may for example be achieved by a voltage driven coil arrangement, as contrary to a constant current driven coil arrangement, where a varying voltage or pulsed constant voltage applied to the magnetic field coil results in the establishment of a time-dependent current pulse. This may preferably be achieved by discharging a capacitor through the magnetic field coil, preferably without further control than the opening and closing of the circuit by the switching arrangement, i.e. without actively controlling the voltage or current development during the discharging. Alternatively, a time-dependent current pulse may be established or controlled by active means, e.g. an operational amplifier, a microcontroller, etc., e.g. the control system.

In an advantageous embodiment, the transmitter unit further comprises an energy source and a recharge switch for recurring energization of the capacitive energy storage.

The advantageous electromagnetic transmitter unit should have the capacitive energy storage recharged after generating a number of sequentially smaller and smaller pulses, e.g. 2, 3, 4, 6, 8, 10, 15 or 20 pulses, due to losses and energy transferred to the fluid. In an embodiment, a small recharging is instead made between each pulse.

In an advantageous embodiment, the energization of the capacitive energy storage comprises a charging of the first capacitor from the energy source.

In an advantageous embodiment, the energy source comprises a battery.

Hereby is connection of an external energy source avoided and the necessary versatility to install the flow meter in any relevant location of a building is present. The invention also ensures that the energy consumption from the batteries is minimized to an extent that the flow meter may be energized from the batteries in many years without any battery replacement.

In an advantageous embodiment, the recurring energization of the capacitive energy storage relates to a voltage of the capacitive energy storage, e.g. a voltage of the first capacitor.

The relation to a voltage of the capacitive energy storage may e.g. involve detection of a voltage and comparison with a predetermined limit value for the voltage, for example the voltage over a capacitor in the capacitive energy storage.

In an advantageous embodiment, the switching arrangement is further configured for terminating the first energy flow from the capacitive energy storage when the current of the first current pulse is zero.

In an advantageous embodiment, the transmitter unit is arranged to establish a digital representation of the first current pulse for signal processing.

As the current pulses established in preferred embodiments of the invention are different and depend on the remaining charge in the capacitive energy storage, thereby also making the established magnetic fields and induced voltages to be different, a representation of the current pulse is preferably established to be able to compensate for the differences in the evaluation of the induced voltage signal.

In an advantageous embodiment, the transmitter unit comprises sampling means arranged as part of said establish a digital representation of the first current pulse.

The transmitter unit may preferably sample the current pulse or an electronically integrated version of one or more current pulses to establish the digital representation of the current pulse(s). The sampled representation of the current pulse may be post-processed, e.g. digitally integrated, filtered, time-trimmed or time-delayed, to establish a digital representation of the transmitted current pulse which can be used by the electromagnetic flow meter in assessing a measured induced voltage to establish fluid flow values.

In an advantageous embodiment, said sampling means are arranged to sample with a sample rate of at least 250 kSPS.

The use of sampling and a high sample rate, preferably at least 250,000 samples per second, ensures that the series of different sized/non-constant, preferably time-dependent pulses is precisely measured or detected.

In an advantageous embodiment, the transmitter unit comprises an electronic integrator for integrating as part of said establish a digital representation of the first current pulse.

The transmitter unit may preferably integrate the current pulse, before or after sampling, i.e. in analog or digital domain, to increase sensitivity and/or to establish a representation of the current pulse which is comparable to a representation of a measured induced voltage in order to use the representation of the current pulse in assessing the measured induced voltage to establish fluid flow values. The integration is preferably performed over a time period (tp), e.g. determined so that the integration covers an integer number of current pulses, e.g. 1 or 2 or 4 pulses, e.g. by a predetermined time or based on detection of zero current to separate pulses.

In an aspect, the invention relates to an electromagnetic transmitter unit for an electromagnetic flow meter arranged to measure a flow rate of a conductive fluid flowing through the flow meter, said transmitter unit comprises: an energy storage, a magnetic field coil, and a switching arrangement; wherein the switching arrangement is configured for effecting a first energy flow from the energy storage to the magnetic field coil and a first energy reflow from the magnetic field coil to the energy storage for generation of a first time-dependent current pulse for transmitting a magnetic field to the conductive fluid.

Hereby is obtained an electromagnetic transmitter unit for an electromagnetic flow meter, with an improved functionality by conserving energy consumption and regeneration of electric charge by controlling energy flow in a quasi resonant circuit between the energy storage and the coil. The control of energy flow allows smaller batteries to be used in the low power flow meter and with a longer operational time.

A further advantage is that the magnetic field polarities can be switched often, or the magnetic field otherwise modulated, without additional energy consumption, thereby enabling suppression of offset and drift errors.

By time-dependent current pulse is referred to a development of current where the current value varies continuously over time between two instances of zero current. A time-dependent current pulse may for example be achieved by a voltage driven coil arrangement, as contrary to a constant current driven coil arrangement, where a varying voltage or pulsed constant voltage applied to the magnetic field coil results in the establishment of a time-dependent current pulse. This may preferably be achieved by discharging a capacitor or other energy storage through the magnetic field coil, preferably without further control than the opening and closing of the circuit by the switching arrangement, i.e. without actively controlling the voltage or current development during the discharging. Alternatively, a time-dependent current pulse may be established or controlled by active means, e.g. an operational amplifier, a microcontroller, etc., e.g. the control system.

In an advantageous embodiment, the switching arrangement is further configured for effecting a second energy flow and a second energy reflow between the energy storage and the magnetic field coil for generation of a second current pulse for transmitting a magnetic field to the conductive fluid.

In an advantageous embodiment, the current of the second current pulse is smaller than the current of the first current pulse.

In an advantageous embodiment, the second energy flow and second energy reflow is more than 80% of the first energy flow and first energy reflow.

In an advantageous embodiment, the energy storage comprises a first capacitor, and wherein the switching arrangement is configured for effecting the first energy flow from the first capacitor to the magnetic field coil and the first energy reflow from the magnetic field coil to the first capacitor.

In an advantageous embodiment, the energy storage comprises a first capacitor and a second capacitor, and wherein the switching arrangement is configured for effecting the first energy flow from the first capacitor to the magnetic field coil and the first energy reflow from the magnetic field coil to the second capacitor.

In an advantageous embodiment, the switching arrangement is configured for effecting the second energy flow from the second capacitor to the magnetic field coil and the second energy reflow from the magnetic field coil to the first capacitor.

In an advantageous embodiment, the magnetic field coil is voltage driven by the capacitive energy storage.

In an advantageous embodiment, the transmitter unit further comprises an energy source and a recharge switch for recurring energization of the energy storage.

In an advantageous embodiment, the energy source comprises a battery.

In an advantageous embodiment, the switching arrangement is further configured for terminating the first energy flow from the energy storage when the current of the first current pulse is zero.

In an advantageous embodiment, the transmitter unit is arranged to establish a digital representation of the first current pulse for signal processing.

In an advantageous embodiment, the transmitter unit comprises sampling means arranged as part of said establish a digital representation of the first current pulse.

In an advantageous embodiment, said sampling means are arranged to sample with a sample rate of at least 250 kSPS.

In an advantageous embodiment, the transmitter unit comprises an electronic integrator for integrating as part of said establish a digital representation of the first current pulse.

In an aspect, the invention relates to an electromagnetic transmitter unit for an electromagnetic flow meter arranged to measure a flow rate of a conductive fluid flowing through the flow meter, said transmitter unit comprises: an energy storage, a magnetic field coil, and a switching arrangement; wherein the switching arrangement is configured for effecting a first energy flow from the energy storage to the magnetic field coil and a first energy reflow from the magnetic field coil to the energy storage for generation of a first current pulse for transmitting a magnetic field to the conductive fluid, wherein the switching arrangement is further configured for effecting a second energy flow and a second energy reflow between the energy storage and the magnetic field coil for generation of a second current pulse for transmitting a magnetic field to the conductive fluid, and wherein the second energy flow and second energy reflow is more than 80% of the first energy flow and first energy reflow.

Hereby is obtained an electromagnetic transmitter unit for an electromagnetic flow meter, with an improved functionality by conserving energy consumption and regeneration of electric charge by controlling energy flow in a quasi resonant circuit between the energy storage and the coil. The control of energy flow allows smaller batteries to be used in the low power flow meter and with a longer operational time.

A further advantage is that the magnetic field polarities can be switched often, or the magnetic field otherwise modulated, without additional energy consumption, thereby enabling suppression of offset and drift errors.

A current of the second current pulse being smaller than the current of the first current pulse refers to the peak current during the pulse, or the integrated current during the pulse, being smaller in the second pulse than in the first pulse. This is advantageous as it allows repeated establishment of a magnetic field for further measurements, at least one further measurement, without recharging the energy storage, e.g. first capacitor, thereby achieving less energy loss. A series of current pulses will preferably have decreasing current peak levels or integrated current, the series consisting of at least two current pulses within a time period. After a certain time period, after a certain number of pulses, or when the current pulse peak level or current pulse start voltage gets below a certain threshold, the capacitive energy storage, e.g. capacitor, is preferably recharged to initialize a new series of decreasing current pulses.

Preferably, the magnetic field coil generates the magnetic field as series of different sized/non-constant pulses within a time period in response to the change of the energy flow. Preferably, the time period is the time between two successive energizations of the capacitive energy storage from an electric energy source.

In a preferred embodiment, the energy loss for each pulse generation is less than 20%, for example less than 15% or less than 10%.

In an advantageous embodiment, the energy storage comprises a first capacitor, and wherein the switching arrangement is configured for effecting the first energy flow from the first capacitor to the magnetic field coil and the first energy reflow from the magnetic field coil to the first capacitor.

In an advantageous embodiment, the energy storage comprises a first capacitor and a second capacitor, and wherein the switching arrangement is configured for effecting the first energy flow from the first capacitor to the magnetic field coil and the first energy reflow from the magnetic field coil to the second capacitor.

In an advantageous embodiment, the switching arrangement is configured for effecting the second energy flow from the second capacitor to the magnetic field coil and the second energy reflow from the magnetic field coil to the first capacitor.

In an advantageous embodiment, the first capacitor and the second capacitor are of the same type and value.

In an advantageous embodiment, the magnetic field coil is voltage driven by the energy storage.

In an advantageous embodiment, the transmitter unit further comprises an energy source and a recharge switch for recurring energization of the energy storage.

In an advantageous embodiment, the energization of the energy storage comprises a charging of a first capacitor from the energy source.

In an advantageous embodiment, the energy source comprises a battery.

In an advantageous embodiment, the recurring energization of the energy storage relates to a voltage of the energy storage, e.g. a voltage of a first capacitor.

In an advantageous embodiment, the switching arrangement is further configured for terminating the first energy flow from the energy storage when the current of the first current pulse is zero.

In an aspect, the invention relates to an electromagnetic transmitter unit for an electromagnetic flow meter arranged to measure a flow rate of a conductive fluid flowing through the flow meter, said transmitter unit comprises: an energy storage, a magnetic field coil, a switching arrangement, an energy source, and a recharge switch; wherein the switching arrangement is configured for effecting a first energy flow from the energy storage to the magnetic field coil and a first energy reflow from the magnetic field coil to the energy storage for generation of a first current pulse for transmitting a magnetic field to the conductive fluid, and wherein the recharge switch is configured for recurring energization of the energy storage from the energy source.

Hereby is obtained an electromagnetic transmitter unit for an electromagnetic flow meter, with an improved functionality by conserving energy consumption and regeneration of electric charge by controlling energy flow in a quasi resonant circuit between the energy storage and the coil. The control of energy flow allows smaller batteries to be used in the low power flow meter and with a longer operational time.

A further advantage is that the magnetic field polarities can be switched often, or the magnetic field otherwise modulated, without additional energy consumption, thereby enabling suppression of offset and drift errors.

The advantageous electromagnetic transmitter unit should have the energy storage recharged after generating a number of sequentially smaller and smaller pulses, e.g. 2, 3, 4, 6, 8, 10, 15 or 20 pulses, due to losses and energy transferred to the fluid. In an embodiment, a small recharging is instead made between each pulse.

In an advantageous embodiment, the switching arrangement is further configured for effecting a second energy flow and a second energy reflow between the energy storage and the magnetic field coil for generation of a second current pulse for transmitting a magnetic field to the conductive fluid.

In an advantageous embodiment, the current of the second current pulse is smaller than the current of the first current pulse.

In an advantageous embodiment, the second energy flow and second energy reflow is more than 80% of the first energy flow and first energy reflow.

In an advantageous embodiment, the energy storage comprises a first capacitor, and wherein the switching arrangement is configured for effecting the first energy flow from the first capacitor to the magnetic field coil and the first energy reflow from the magnetic field coil to the first capacitor.

In an advantageous embodiment, the energy storage comprises a first capacitor and a second capacitor, and wherein the switching arrangement is configured for effecting the first energy flow from the first capacitor to the magnetic field coil and the first energy reflow from the magnetic field coil to the second capacitor.

In an advantageous embodiment, the switching arrangement is configured for effecting the second energy flow from the second capacitor to the magnetic field coil and the second energy reflow from the magnetic field coil to the first capacitor.

In an advantageous embodiment, the first capacitor and the second capacitor are of the same type and value.

In an advantageous embodiment, the magnetic field coil is voltage driven by the energy storage.

In an advantageous embodiment, the energization of the energy storage comprises a charging of a first capacitor from the energy source.

In an advantageous embodiment, the energy source comprises a battery.

In an advantageous embodiment, the recurring energization of the energy storage relates to a voltage of the energy storage, e.g. a voltage of a first capacitor.

In an advantageous embodiment, the switching arrangement is further configured for terminating the first energy flow from the energy storage when the current of the first current pulse is zero.

In an aspect, the invention relates to an electromagnetic transmitter unit for an electromagnetic flow meter arranged to measure a flow rate of a conductive fluid flowing through the flow meter, said transmitter unit comprises: an energy storage, a magnetic field coil, and a switching arrangement; wherein the switching arrangement is configured for effecting a first energy flow from the energy storage to the magnetic field coil and a first energy reflow from the magnetic field coil to the energy storage for generation of a first current pulse for transmitting a magnetic field to the conductive fluid, wherein the switching arrangement is further configured for effecting a second energy flow and a second energy reflow between the energy storage and the magnetic field coil for generation of a second current pulse for transmitting a magnetic field to the conductive fluid, and wherein the current of the second current pulse is smaller than the current of the first current pulse.

Hereby is obtained an electromagnetic transmitter unit for an electromagnetic flow meter, with an improved functionality by conserving energy consumption and regeneration of electric charge by controlling energy flow in a quasi resonant circuit between the energy storage and the coil. The control of energy flow allows smaller batteries to be used in the low power flow meter and with a longer operational time.

A further advantage is that the magnetic field polarities can be switched often, or the magnetic field otherwise modulated, without additional energy consumption, thereby enabling suppression of offset and drift errors.

A current of the second current pulse being smaller than the current of the first current pulse refers to the peak current during the pulse, or the integrated current during the pulse, being smaller in the second pulse than in the first pulse. This is advantageous as it allows repeated establishment of a magnetic field for further measurements, at least one further measurement, without recharging the energy storage, e.g. first capacitor, thereby achieving less energy loss. A series of current pulses will preferably have decreasing current peak levels or integrated current, the series consisting of at least two current pulses within a time period. After a certain time period, after a certain number of pulses, or when the current pulse peak level or current pulse start voltage gets below a certain threshold, the capacitive energy storage, e.g. capacitor, is preferably recharged to initialize a new series of decreasing current pulses.

Preferably, the magnetic field coil generates the magnetic field as series of different sized/non-constant pulses within a time period in response to the change of the energy flow. Preferably, the time period is the time between two successive energizations of the capacitive energy storage from an electric energy source.

In an advantageous embodiment, the second energy flow and second energy reflow is more than 80% of the first energy flow and first energy reflow.

In an advantageous embodiment, the energy storage comprises a first capacitor, and wherein the switching arrangement is configured for effecting the first energy flow from the first capacitor to the magnetic field coil and the first energy reflow from the magnetic field coil to the first capacitor.

In an advantageous embodiment, the energy storage comprises a first capacitor and a second capacitor, and wherein the switching arrangement is configured for effecting the first energy flow from the first capacitor to the magnetic field coil and the first energy reflow from the magnetic field coil to the second capacitor.

In an advantageous embodiment, the switching arrangement is configured for effecting the second energy flow from the second capacitor to the magnetic field coil and the second energy reflow from the magnetic field coil to the first capacitor.

In an advantageous embodiment, the first capacitor and the second capacitor are of the same type and value.

In an advantageous embodiment, the magnetic field coil is voltage driven by the energy storage.

In an advantageous embodiment, the transmitter unit further comprises an energy source and a recharge switch for recurring energization of the energy storage.

In an advantageous embodiment, the energization of the energy storage comprises a charging of a first capacitor from the energy source.

In an advantageous embodiment, the energy source comprises a battery.

In an advantageous embodiment, the recurring energization of the energy storage relates to a voltage of the energy storage, e.g. a voltage of a first capacitor.

In an advantageous embodiment, the switching arrangement is further configured for terminating the first energy flow from the energy storage when the current of the first current pulse is zero.

In an advantageous embodiment, the transmitter unit is arranged to establish a digital representation of the first current pulse for signal processing.

In an advantageous embodiment, the transmitter unit comprises sampling means arranged as part of said establish a digital representation of the first current pulse.

In an advantageous embodiment, said sampling means are arranged to sample with a sample rate of at least 250 kSPS.

In an advantageous embodiment, the transmitter unit comprises an electronic integrator for integrating as part of said establish a digital representation of the first current pulse.

In an aspect, the invention relates to an electromagnetic transmitter unit for an electromagnetic flow meter arranged to measure a flow rate of a conductive fluid flowing through the flow meter, said transmitter unit comprises: an energy storage, a magnetic field coil, and a switching arrangement; wherein the switching arrangement is configured for effecting a first energy flow from the energy storage to the magnetic field coil and a first energy reflow from the magnetic field coil to the energy storage for generation of a first current pulse for transmitting a magnetic field to the conductive fluid, and further configured for terminating the first energy flow from the capacitive energy storage when the current of the first current pulse is zero.

Hereby is obtained an electromagnetic transmitter unit for an electromagnetic flow meter, with an improved functionality by conserving energy consumption and regeneration of electric charge by controlling energy flow in a quasi resonant circuit between the energy storage and the coil. The control of energy flow allows smaller batteries to be used in the low power flow meter and with a longer operational time.

A further advantage is that the magnetic field polarities can be switched often, or the magnetic field otherwise modulated, without additional energy consumption, thereby enabling suppression of offset and drift errors.

In an advantageous embodiment, the switching arrangement is further configured for effecting a second energy flow and a second energy reflow between the energy storage and the magnetic field coil for generation of a second current pulse for transmitting a magnetic field to the conductive fluid.

In an advantageous embodiment, the current of the second current pulse is smaller than the current of the first current pulse.

In an advantageous embodiment, the second energy flow and second energy reflow is more than 80% of the first energy flow and first energy reflow.

In an advantageous embodiment, the energy storage comprises a first capacitor, and wherein the switching arrangement is configured for effecting the first energy flow from the first capacitor to the magnetic field coil and the first energy reflow from the magnetic field coil to the first capacitor.

In an advantageous embodiment, the energy storage comprises a first capacitor and a second capacitor, and wherein the switching arrangement is configured for effecting the first energy flow from the first capacitor to the magnetic field coil and the first energy reflow from the magnetic field coil to the second capacitor.

In an advantageous embodiment, the switching arrangement is configured for effecting the second energy flow from the second capacitor to the magnetic field coil and the second energy reflow from the magnetic field coil to the first capacitor.

In an advantageous embodiment, the first capacitor and the second capacitor are of the same type and value.

In an advantageous embodiment, the magnetic field coil is voltage driven by the energy storage.

In an advantageous embodiment, the first current pulse is a first time-dependent current pulse.

In an advantageous embodiment, the transmitter unit further comprises an energy source, e.g. a battery, and a recharge switch for recurring energization of the energy storage.

In an advantageous embodiment, the transmitter unit is arranged to establish a digital representation of the first current pulse for signal processing.

In an advantageous embodiment, the transmitter unit comprises sampling means arranged as part of said establish a digital representation of the first current pulse.

In an advantageous embodiment, said sampling means are arranged to sample with a sample rate of at least 250 kSPS.

In an advantageous embodiment, the transmitter unit comprises an electronic integrator for integrating as part of said establish a digital representation of the first current pulse.

In an aspect, the invention relates to an electromagnetic transmitter unit for an electromagnetic flow meter arranged to measure a flow rate of a conductive fluid flowing through the flow meter, said transmitter unit comprises: an energy storage, a magnetic field coil, and a switching arrangement; wherein the switching arrangement is configured for effecting a first energy flow from the energy storage to the magnetic field coil and a first energy reflow from the magnetic field coil to the energy storage for generation of a first current pulse for transmitting a magnetic field to the conductive fluid, and wherein the transmitter unit is arranged to establish a digital representation of the first current pulse for signal processing.

Hereby is obtained an electromagnetic transmitter unit for an electromagnetic flow meter, with an improved functionality by conserving energy consumption and regeneration of electric charge by controlling energy flow in a quasi resonant circuit between the energy storage and the coil. The control of energy flow allows smaller batteries to be used in the low power flow meter and with a longer operational time.

A further advantage is that the magnetic field polarities can be switched often, or the magnetic field otherwise modulated, without additional energy consumption, thereby enabling suppression of offset and drift errors.

As the current pulses established in preferred embodiments of the invention are different and depend on the remaining charge in the capacitive energy storage, thereby also making the established magnetic fields and induced voltages to be different, a representation of the current pulse is preferably established to be able to compensate for the differences in the evaluation of the induced voltage signal.

In an advantageous embodiment, the transmitter unit comprises sampling means arranged as part of said establish a digital representation of the first current pulse.

In an advantageous embodiment, said sampling means are arranged to sample with a sample rate of at least 250 kSPS.

In an advantageous embodiment, the transmitter unit comprises an electronic integrator for integrating as part of said establish a digital representation of the first current pulse.

In an advantageous embodiment, the switching arrangement is further configured for effecting a second energy flow and a second energy reflow between the energy storage and the magnetic field coil for generation of a second current pulse for transmitting a magnetic field to the conductive fluid.

In an advantageous embodiment, the current of the second current pulse is smaller than the current of the first current pulse.

In an advantageous embodiment, the second energy flow and second energy reflow is more than 80% of the first energy flow and first energy reflow.

In an advantageous embodiment, the energy storage comprises a first capacitor, and wherein the switching arrangement is configured for effecting the first energy flow from the first capacitor to the magnetic field coil and the first energy reflow from the magnetic field coil to the first capacitor.

In an advantageous embodiment, the energy storage comprises a first capacitor and a second capacitor, and wherein the switching arrangement is configured for effecting the first energy flow from the first capacitor to the magnetic field coil and the first energy reflow from the magnetic field coil to the second capacitor.

In an advantageous embodiment, the switching arrangement is configured for effecting the second energy flow from the second capacitor to the magnetic field coil and the second energy reflow from the magnetic field coil to the first capacitor.

In an advantageous embodiment, the first capacitor and the second capacitor are of the same type and value.

In an advantageous embodiment, the magnetic field coil is voltage driven by the energy storage.

In an advantageous embodiment, the first current pulse is a first time-dependent current pulse.

In an advantageous embodiment, the transmitter unit further comprises an energy source, e.g. a battery, and a recharge switch for recurring energization of the energy storage.

In an advantageous embodiment, the switching arrangement is further configured for terminating the first energy flow from the energy storage when the current of the first current pulse is zero.

In an advantageous embodiment of any of the above electromagnetic transmitter units the switching arrangement comprises a rectifier of the energy flow through the magnetic field coil.

Preferably, the switching arrangement includes an active or passive rectifier of the energy flow/current through the magnetic field coil such as an active circuit with current measurement and disconnection of the current path e.g. an ideal diode circuit or a passive diode e.g. a Schottky diode. The rectifier ensures that the current may only flow in one direction until a new steady state is reached and hereby allow a charge shift between a first and second capacitor. The active rectifier circuit works in similar manner as a passive Schottky diode but may be implemented with a lower forward loss than the diode (which already has low forward loss functionality) but with a slightly higher circuit complexity. The possibility of low forward loss in the rectifier is especially of great importance in a low voltage circuit as the present flow meter.

In an advantageous embodiment of any of the above electromagnetic transmitter units the magnetic field coil is arranged in an H-bridge structure of switches.

This allows the direction of the current in the coil to be changed between measurements. The benefit of this is, that the resulting magnetic field will reverse and thus the measured voltage between the pickup electrodes in the voltage detector of the flow meter. This means that offset in the small measured voltage between the pickup electrodes can be eliminated by subtracting two measurements obtained by opposing magnetic fields. As voltages measured with reversed magnetic polarity have reversed sign, a subtraction of a reversed voltage from a non-reversed voltage will effectively add the numeric values, thereby doubling the utility value, but reducing or eliminating the offset error. Voltage offsets may especially be minimized by frequently changing direction of magnetic field from the coil. This advantages applies to both offset errors originating from the electrical circuits, as well as noise picked up by the electrodes.

In an advantageous embodiment of any of the above electromagnetic transmitter units the magnetic field coil is protected by a snubber circuit.

Snubbers are added to prevent kickback voltages from the coil to damage switches or other delicate electric parts of the flow meter and prevent kickback voltages being a source of electromagnetic interference EMI. Excessive energy in the coil at the switching time may for example be safely directed to a ground potential, or another charge sink/source.

In an aspect, the invention relates to an electromagnetic flow meter arranged to measure a flow rate of a conductive fluid flowing through the flow meter, said flow meter comprises:

an electromagnetic transmitter unit according to any of the claims 1-100 for transmitting a magnetic field to the conductive fluid,

a detector unit for measuring an induced voltage signal induced by the magnetic field, and

a control system for controlling the operation of the electromagnetic transmitter unit and the detector unit in establishing a value of the fluid flow rate.

Hereby is obtained an electromagnetic flow meter with an improved functionality by conserving energy consumption and regeneration of electric charge by controlling energy flow in an LC (quasi resonant) circuit. The control of energy flow allows smaller batteries to be used in the low power flow meter and with a longer operational time.

A further advantage is that the magnetic field polarities can be switched often, or the magnetic field otherwise modulated, without additional energy consumption, thereby enabling suppression of offset and drift errors.

A capacitive energy storage refers to an energy storage comprising at least one capacitor, such as for example just one capacitor, two capacitors, several capacitors, a combination of one or more capacitors with one or more batteries, etc. The at least one capacitor of the capacitive energy storage may be a discrete or integrated capacitor component, or may be an intrinsic capacitance of another component.

The magnetic field coil may be one or more coils equivalent to one coil from an electric circuit perspective.

In an advantageous embodiment, the control system is configured for evaluating a relationship between the energy flow in the electromagnetic transmitter unit and the induced voltage signal in the detector unit in establishing a value of the fluid flow rate.

In an advantageous embodiment, the detector unit comprises:

a voltage detector for measuring an induced voltage signal from the transmitted magnetic field via the conductive fluid flowing through the flow meter, and

an evaluating arrangement for evaluating the induced voltage as measured by the detector.

In an advantageous embodiment, the voltage detector is arranged to establish a digital representation of the induced voltage signal.

In an advantageous embodiment, the voltage detector comprises sampling means arranged as part of said establish a digital representation of the induced voltage signal.

The voltage detector may preferably sample the induced voltage signal or an electronically integrated version of one or more induced voltage signals to establish the digital representation of the induced voltage signal(s). The sampled representation of the induced voltage signal may be post-processed, e.g. digitally integrated, filtered, time-trimmed or time-delayed, to establish a digital representation of the measured induced voltage signal which can be used by the electromagnetic flow meter in establishing fluid flow values.

In an advantageous embodiment, said sampling means are arranged to sample with a sample rate of at least 250 kSPS.

In an advantageous embodiment, the voltage detector comprises an electronic integrator for integrating as part of said establish a digital representation of the induced voltage signal.

The voltage detector may preferably integrate the induced voltage signal, before or after sampling, i.e. in analog or digital domain, to increase sensitivity. The integration is preferably performed over a time period (tp), e.g. determined so that the integration covers an integer number of induced voltage signal corresponding to current pulses, e.g. 1 or 2 or 4 pulses, e.g. by a predetermined time or based on detection of zero current to separate pulses.

In an advantageous embodiment, the voltage detector comprises two pickup electrodes.

In an aspect, the invention relates to a method for measuring a flow rate of a conductive fluid flowing through an electromagnetic flow meter including an electromagnetic transmitter unit, a detector unit, and a control system, the method comprising the steps of:

effecting with a switching arrangement operated by the control system a first energy flow from a capacitive energy storage of the transmitter unit to the magnetic field coil of the transmitter unit and a first energy reflow from the magnetic field coil to the capacitive energy storage for generation of a first current pulse for transmitting a magnetic field to the conductive fluid,

measuring an induced voltage signal induced by the transmitted magnetic field via the conductive fluid with a voltage detector in the detector unit, and

determining the flow rate of the conductive fluid from the energy flow and the induced voltage signal.

In an advantageous embodiment, the method comprises a further step of:

effecting with the switching arrangement a second energy flow and a second energy reflow between the capacitive energy storage and the magnetic field coil for generation of a second current pulse for transmitting a magnetic field to the conductive fluid.

In an advantageous embodiment, the method comprises generating the second current pulse with a smaller current than the generated first current pulse.

In an advantageous embodiment, the method comprises effecting the second energy flow and second energy reflow at more than 80% of the effected first energy flow and first energy reflow.

In an advantageous embodiment, the capacitive energy storage comprises a first capacitor, and wherein the method comprises effecting the first energy flow from the first capacitor to the magnetic field coil and the first energy reflow from the magnetic field coil to the first capacitor.

In an advantageous embodiment, the capacitive energy storage comprises a first capacitor and a second capacitor, and wherein the method comprises effecting the first energy flow from the first capacitor to the magnetic field coil and the first energy reflow from the magnetic field coil to the second capacitor.

In an advantageous embodiment, the method comprises effecting the second energy flow from the second capacitor to the magnetic field coil and the second energy reflow from the magnetic field coil to the first capacitor.

In an advantageous embodiment, the method comprises a step of recurrently energizing the capacitive energy storage from an energy source, preferably a battery.

In an advantageous embodiment, the energizing of the capacitive energy storage comprises charging the first capacitor.

In an advantageous embodiment, the method comprises terminating the first energy flow from the capacitive energy storage when the current of the first current pulse is zero.

In an advantageous embodiment, the method comprises establishing a digital representation of the first current pulse for signal processing.

### THE DRAWINGS

Various embodiments of the invention will in the following be described, by way of example only, with reference to the accompanying drawings, which will be understood to be illustrative only, and are not provided to scale.

FIG. 1 illustrates an electromagnetic flow meter and the measuring principle of an electromagnetic flow meter,

FIG. 2 illustrates elements of an electromagnetic flow meter,

FIGS. 3A and 3B illustrate principle aspects of an electromagnetic transmitter unit of an electromagnetic flow meter according to the invention,

FIGS. 4A and 4B illustrate aspects of an electromagnetic transmitter unit with one capacitor of an electromagnetic flow meter according to the invention,

FIGS. 5A and 5B illustrate aspects of an electromagnetic transmitter unit with two capacitors of an electromagnetic flow meter according to the invention,

FIGS. 6A and 6B illustrate an embodiment of an electromagnetic transmitter unit of an electromagnetic flow meter according to the invention,

FIGS. 7A and 7B illustrate further embodiments of an electromagnetic transmitter unit of an electromagnetic flow meter according to the invention,

FIG. 8 illustrates an even further embodiment of an electromagnetic transmitter unit for an electromagnetic flow meter according to the invention,

FIGS. 9A and 9B illustrate an embodiment of a detector unit for an electromagnetic flow meter according to the invention,

FIG. 10 illustrates elements of an embodiment of the electromagnetic flow meter according to the invention,

FIG. 11 illustrates an example of the relationship between values in the electromagnetic transmitter unit and detector unit of the electromagnetic flow meter according to the invention,

FIG. 12 illustrates a flow diagram for the functionality of the electromagnetic transmitter unit in the electromagnetic flow meter according to the invention, and

FIG. 13 illustrates a flow diagram for the functionality of the detector unit in the electromagnetic flow meter according to the invention.

### DETAILED DESCRIPTION

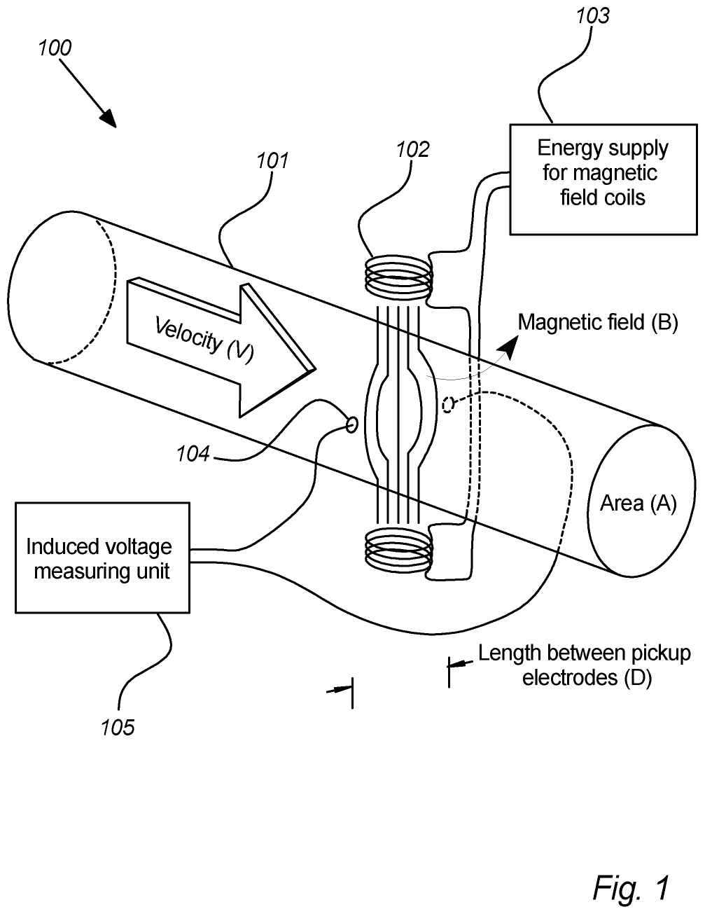

FIG. 1 illustrates the measuring principle of an electromagnetic flow meter 100.

A volume of fluid flow may be measured with an electromagnetic flow meter by measuring the velocity of fluid (V) over a known area (A) such as the cross-section area of a pipe or tube 101 wherein the fluid flows. Electromagnetic flow meters use Faraday's law of electromagnetic induction, which states that a voltage will be induced in a conductor moving through a magnetic field (B). The liquid serves as the conductor; the magnetic field is created by energized coils 102. The induced voltage is measured with pickup electrodes 104 located at the circumference of the pipe or tube 101 and a connected measuring unit 105 for the induced voltage. The measuring unit 105 may include a display in the electromagnetic flow meter 100 for indicating the measured volume of fluid flow, temporary storage for measured data of the volume of fluid flow and/or means for wirelessly communicating the measured data to a remote location for final processing and storage.

Faraday's law states U=k*B*D*V where V in the equation is the velocity of a conductive fluid as also indicated in the figure with a large arrow. B is the magnetic field strength created by the energized coils 102 as indicated in the figure with field lines and an energy supply 103 for the magnetic field coils 102. D is the spacing between the pickup electrodes and U is the induced voltage measured across the electrodes.

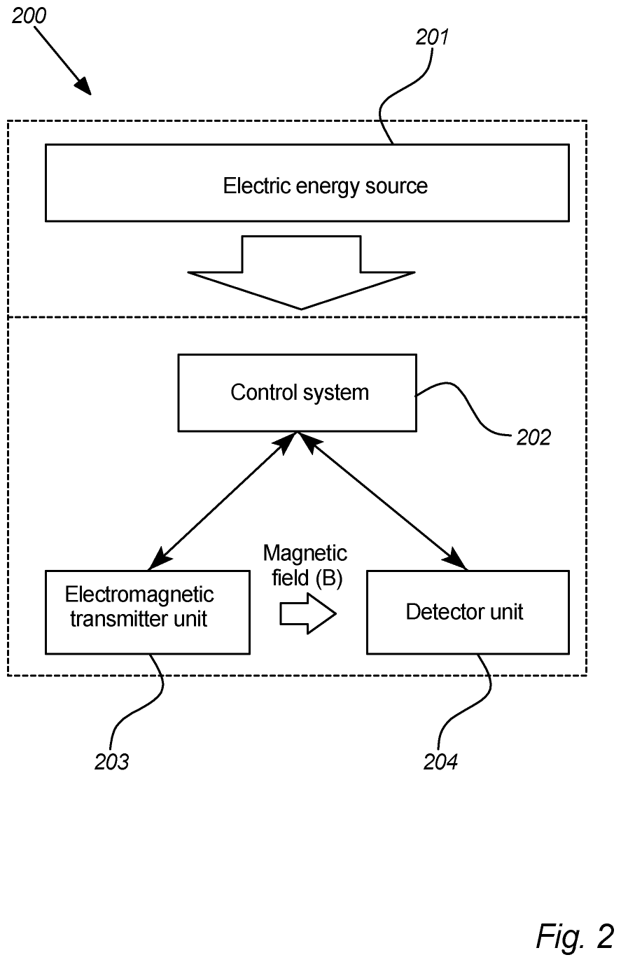

FIG. 2 illustrates an electromagnetic flow meter 200 comprising an electromagnetic transmitter unit 203 for transmitting a magnetic field (B) with a magnetic field coil to a flowing conductive fluid. The magnetic field is detected as an induced voltage by a voltage detector with pickup electrodes in a detector unit 204.

The functionality of the electromagnetic transmitter unit 203 and the detector unit 204 is controlled and monitored from a control system 202 in the electromagnetic flow meter 200.

The different electric parts of the electromagnetic flow meter 200 such as the electromagnetic transmitter unit 203, the detector unit 204, and the control system 202 are powered from an electric energy source 201. The electric energy source 201 is preferably one or more electric batteries stored in the housing of the electromagnetic flow meter 200 and with electric connections to said different electric parts of the electromagnetic flow meter 200.

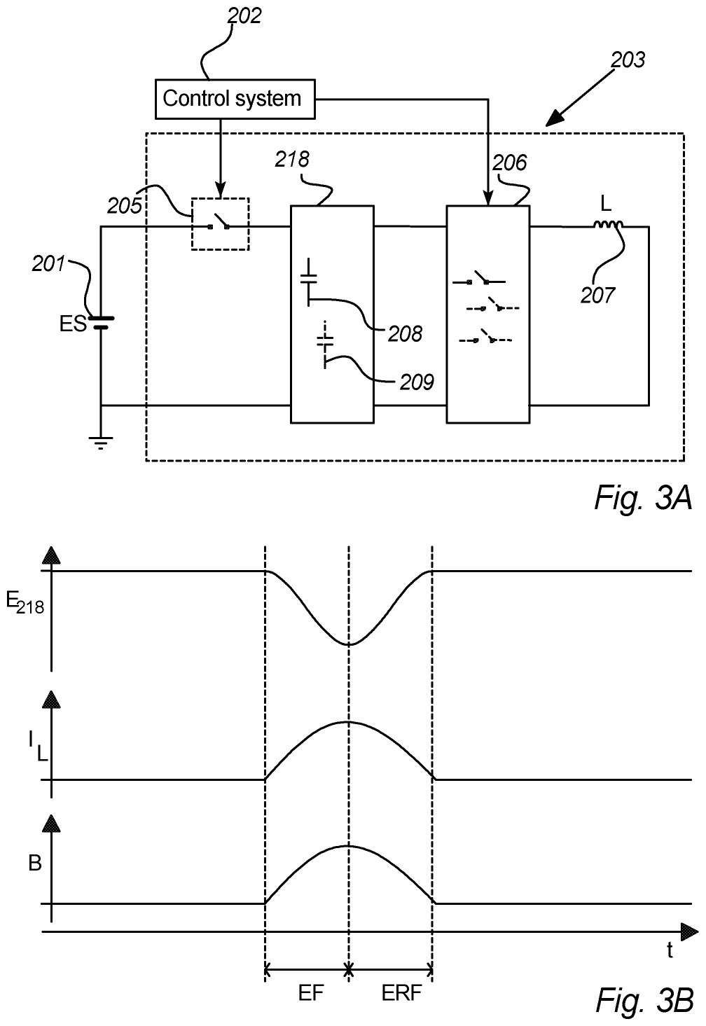

FIG. 3A illustrates the first aspects of an electromagnetic transmitter unit 203 of an electromagnetic flow meter 200 according to the invention in the form of a principal block diagram.

The electromagnetic transmitter unit 203 comprises a capacitive energy storage 218 and an inductor L as a magnetic field coil 207 (or two or more magnetic field coils 207 in a serial connection). The electric components also comprise a switching arrangement 206 for opening and closing circuits between the capacitive energy storage 218 and the magnetic field coil 207.

The capacitive energy storage 218 preferably comprises one or two capacitors, and may in various embodiments comprise other components with capacitive characteristics, and/or other energy storage components. In an embodiment the capacitive energy storage 218 comprises a battery and a capacitor. Capacitive energy storages will be described in more detail below.

The switching arrangement 206 may comprises one or more electronically controllable switches such as transistors, relays, etc., and may also comprise other components for facilitating the desired control of the circuits, e.g. diodes or other rectifier components. Switching arrangements will be described in more detail below.

The general mode of operation, including several embodiments described in more detail below, is to
have an electrical energy E₂₁₈ stored in the capacitive energy storage 218,
at a time controlled via the switching arrangement 206, establish an energy flow EF from the capacitive energy storage 218 to the magnetic field coil 207,
the energy flow to the coil establishing a current I_{L} in the coil, thereby establishing a magnetic field B,
the energy flow EF discharging the capacitive energy storage 218,
allow the flywheel effect of the coil to establish an energy reflow ERF from the magnetic field coil 207 to the capacitive energy storage 218,
the energy reflow to the capacitive energy storage consuming the magnet field B, reducing the current I_{L} to zero,
the energy reflow ERF charging the capacitive energy storage 218, and
at a time controlled via the switching arrangement 207, stopping the energy flow and energy reflow.

FIG. 3B illustrates a principle example of the development of energy E₂₁₈ in the capacitive energy storage 218, current I_{L} in the magnetic field coil 207, and magnet field B over the time t described in the general mode of operation above.

As can be seen from the curves, when the switching arrangement 206 closes the circuits to allow discharging the capacitive energy storage into the magnetic field coil, the energy E₂₁₈ decrease during the energy flow EF interval, until a certain minimum amount or zero energy is left in the capacitive energy storage 218. Simultaneously, the energy flow EF causes establishment of a current I_{L} in the coil, and thereby a proportional magnet field B. When the energy flow EF fades and finally stops, the magnetic field coil 207 attempts to maintain the current I_{L} due to its flywheel characteristic, and thereby causes an energy reflow ERF of energy back to the capacitive energy storage 218, resulting in an increasing energy E₂₁₈ there, with fading current I_{L} and magnet field B as result. By design and/or control of the switching arrangement 206, the circuit is preferably broken at this point to stop the system from restarting an energy flow in the coil automatically and immediately.

The principle curves shown in FIG. 3B assumes an ideal, lossless circuit. In a practical embodiment, the energy reflow ERF and thereby the energy E₂₁₈ stored in the capacitive energy storage 218 at the end of the process, would be lower than the starting amount of energy E₂₁₈, as will be discussed further below. To compensate for this real-world challenge, and to initialize the electromagnetic transmitter unit in the first place, and energy source ES, 201, for example a battery, may be provided to charge or top-up the energy E₂₁₈ of the capacitive energy storage. A recharge switch 205 is provided to be able to control the recharging of the capacitive energy storage 218.

As mentioned, the time-dependent current pulse, i.e. current varies with time as opposed to a constant current pulse, has caused a magnet field pulse to be established through the flow tube of the electromagnetic flow meter, which again as explained above, has caused a voltage to be induced between a pair of electrodes, thereby usable to derive an indication about the flow velocity.

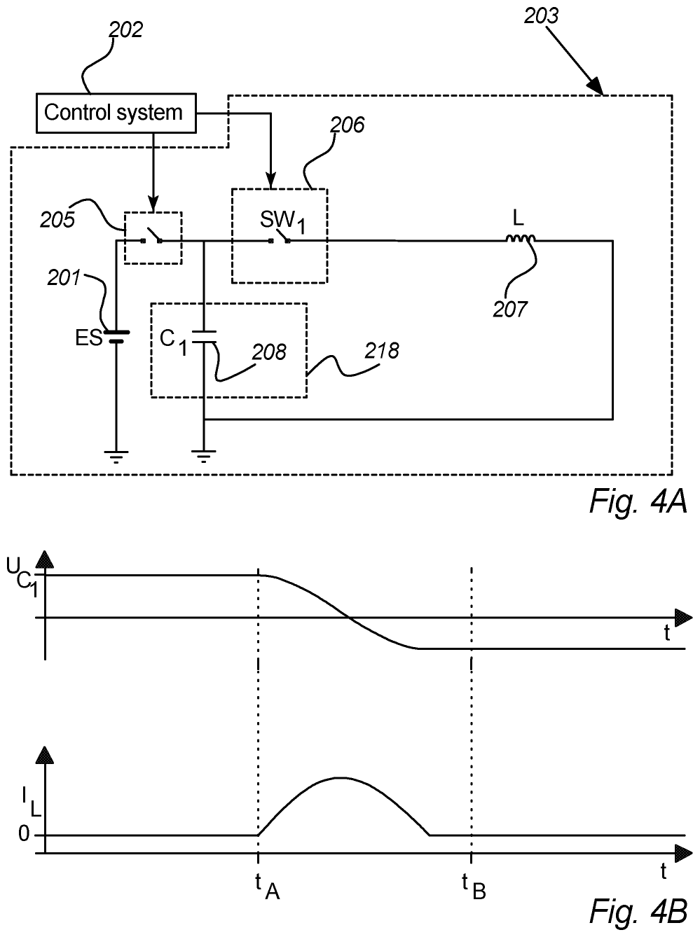

FIG. 4A illustrates an embodiment of an electromagnetic transmitter unit 203 in accordance with the above general description. As described above, the transmitter unit again comprises a magnetic field coil 207, a capacitive energy storage 208 and a switching arrangement 206 to enable energy flow and energy reflow between the capacitive energy storage and the coil. In this embodiment, the switching arrangement 206 simply comprises a controllable switch SW₁, and the capacitive energy storage simply comprises a capacitor C₁, 208, or a an equivalent bank of capacitors or components with capacitance characteristics.

As described above, an energy source 201 and a recharge switch 205 is provided to initialize or top-up the capacitive energy storage, in this case the single capacitor 208. A control system 202 is provided to control the switches for both the recharging, and the energy flow and energy reflow.

FIG. 4B illustrates the development of capacitor voltage U_{C1} and coil current I_{L} over a time interval from t_{A} where the switching arrangement 206 is controlled to start an energy flow, and to t_{B} which is after the switching arrangement 206 has stopped the quasi oscillation again.

As illustrated, when the switching arrangement 206 closes the circuit, the charged capacitor 208 discharges through the coil and back to the opposite plate of capacitor 208. When capacitor is fully discharged, the energy flow EF ends naturally, but as a current has been established, the coil tries to maintain the current and thereby draws further charge out of the first plate of the capacitor 208, and puts it into the opposite plate of capacitor 208, thereby reversing the polarity and voltage sign of the capacitor 208 and voltage U_{C1}. The control system 202 intervenes and causes the switching arrangement 206 to open the circuit, and thereby avoid an automatic and immediate reverse energy flow, i.e. avoiding a true oscillation. Instead is achieved that the initial amount of energy, except for a small loss, has been restored in the capacitive energy storage 218 and can be reused by engaging the switching arrangement 206 again at an appropriate time. Due to the now reversed polarity of the re-charged capacitor, the next energy flow and energy reflow will even cause the polarity of the magnet field to be opposite the first magnet field, which is a great achievement normally requiring control mechanisms or even mechanical solutions and plenty of time to achieve.

As mentioned, the time-dependent current pulse has caused a magnet field pulse to be established through the flow tube of the electromagnetic flow meter, which again as explained above, has caused a voltage to be induced between a pair of electrodes, thereby usable to derive an indication about the flow velocity.

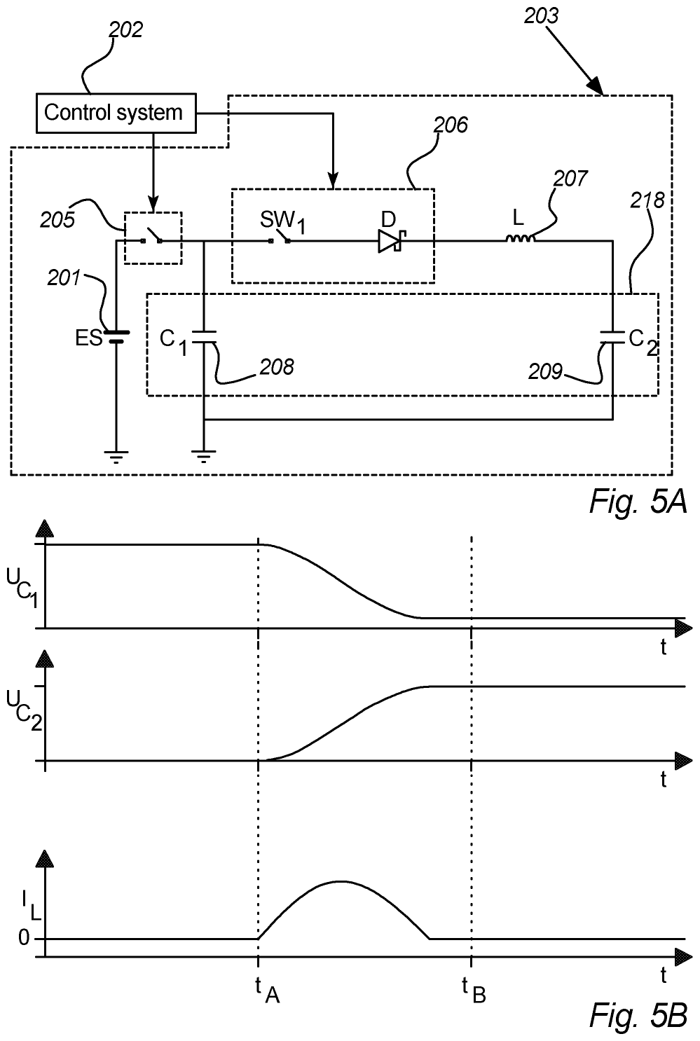

FIG. 5A illustrates another embodiment of an electromagnetic transmitter unit 203 in accordance with the above general description of FIG. 3A and 3B. The electric components of the electromagnetic transmitter unit 203 include now as the capacitive energy storage 218 two capacitors C₁, 208, C₂, 209, and an inductor L as a magnetic field coil 207 (or two or more magnetic field coils 207 in a serial connection) in the transmitter unit. The electric components also include a switch SW₁ and a diode D as components in a reduced switching arrangement 206. The diode is preferably a Schottky diode as illustrated in the figure.

The switching operation of the switch SW₁ is controlled by the control system 202 which also controls a switch 205 to connect and disconnect the electric energy source 201 from the first capacitor 208 when energization of the capacitive energy storage 218 is necessary e.g. detection of a first capacitor voltage that has dropped below a predefined limit value.

The functionality of the electromagnetic transmitter unit 203 illustrated in FIG. 5A is as follows:
The first capacitor C₁, 208 is initially charged to a fixed voltage by the electric energy source 201 and the second capacitor C₂, 209 is practically uncharged.
When the switch SW₁ is closed, current will start flowing through the diode D and the magnetic field coil L towards the second capacitor 209. The inductance of the coil L will prevent an abrupt change in current, so no current or voltage spikes will be generated.
Instead, the current will increase until the voltage on the capacitors reaches equilibrium.
At that point the current will start to decrease back to zero. Due to the diode D, the current cannot go below zero and thus the circuit reaches a new steady state.

FIG. 5B illustrates the curves of the voltages U_{C1}, U_{C2} for the first and second capacitors C₁, C₂, 208, 209, and the current curve I_{L} of the current flowing through the magnetic field coil L as a result of the above-mentioned functionality of the electromagnetic transmitter unit 203.

As illustrated in the figure, the current curve I_{L} is approximately zero in a time period outside a first and second time t_{A} and t_{B} is wherein a current pulse is present. The first time t_{A} is the time after the first above bullet point and after the switch SW₁ has been closed whereby the current starts to flow through the diode D and the magnetic field coil L, 207 as disclosed in the second bullet point. The time t_{B} is the time after the third and fourth bullet points have been performed and the current has stopped flowing through the diode D and the magnetic field coil L.

A main point in the functionality of the electromagnetic transmitter unit 203 is that because the current still flows even when the voltage had reached equilibrium then the mentioned new steady state has a lower voltage on first capacitor C1, 208 than on the second capacitor C2, 209.

In fact, in ideal circumstances (wherein the size of the first capacitor C₁ equals the second capacitor C₂, no voltage over the diode D, and no resistance in the magnetic field coil L or the circuit in general), then the voltages would now be reversed, with the first capacitor C₁ being uncharged and the second capacitor C₂ holding the voltage initially on the first capacitor C₁.

Some electric energy will be lost in a real electromagnetic transmitter unit 203 with real electric components as indicated on the y-axis of the voltage curves illustrated in FIG. 5B.

The electric components of the circuit may for example be a magnetic field coil L of a smaller value than 100 millihenry and larger than 100 microhenry such as 500 microhenry and for example the first capacitor C₁ and the second capacitor C₂ being capacitors of equal value such as 100 nanofarad. The voltages U_{C1}, U_{C2} for the first and second capacitors C₁, C₂, 208, 209 may for example range between zero and 4 volt DC and the current maximum may be in range of 30 to 40 milliampere. Similar values apply to a preferred embodiment of the one-capacitor solution described above with reference to FIG. 4A.

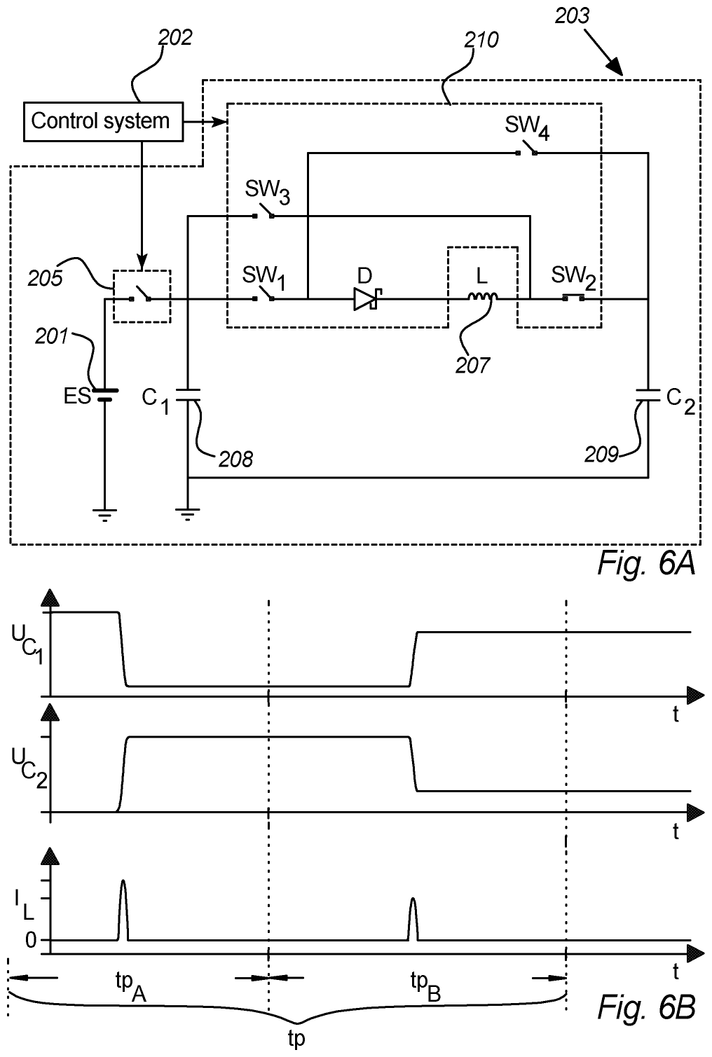

FIG. 6A illustrates an embodiment of an electromagnetic transmitter unit 203 of an electromagnetic flow meter 200 according to the invention.

The circuit in the figure comprises the same electric components as disclosed in FIG. 5A including the first switch SW₁. In order to utilize the electrical energy that has moved to the second capacitor C₂, a full switching arrangement 210 is applied to the circuit, so that the current also can flow in the opposite direction through the magnetic field coil L and back to the first capacitor C₁.

The first switch SW₁ and a number of further switches SW₂, SW₃ and SW₄ together with the diode D form the full switching arrangement 210. The operation of the different switches is controlled from the control system 202.

The functionality of the electromagnetic transmitter unit 203 illustrated in FIGS. 6A is as follows:
Initially the switches SW₁, SW₃ and SW₄ are open and switch SW₂ is closed, so in case of ideal switches the circuit is equal to the illustrated circuit in FIG. 5A in this present moment.
The charge on first capacitor C₁ is moved to the second capacitor C₂ by closing SW₁. This means that a current will start flowing through the diode D and the magnetic field coil L in a similar manner as described before in connection with FIGS. 5A and 5B.
After the charge on first capacitor C₁ is moved to the second capacitor C₂ by closing SW₁ then SW₁ and SW₂ are opened, and SW₃ and SW₄ are closed. This means that a current will start flowing from the second capacitor C₂ to the first capacitor C₁ through the diode D and the magnetic field coil L in a similar manner as described above.

The functionality of the electromagnetic transmitter unit 203 illustrated in

FIGS. 6A and explained with the above bullet points will establish a first and second current pulse through the coil L. A functionality that may be repeated by operating the switches SW₁ to SW₄ with the control system 202 until the voltage U_{C1} for the first capacitor C₁ has dropped to a predetermined limit value.

The control system 202 operates the switch 205 to a closed position when the voltage U_{C1} for the first capacitor C₁ have dropped to a predetermined limit value and allows the electric energy source ES to connect and recharge the first capacitor C₁ to a fixed voltage. The control system 202 ends the recharging operation for the first capacitor C₁ when it is fully recharged and disconnects the electric energy source ES by opening the switch 205. The control system 202 also initiates the switching of the switches SW₁ to SW₄ in the switching arrangement 210 for arranging the energy flow through the at least one magnetic field coil L.

FIG. 6B illustrates the curves of the voltages U_{C1}, U_{C2} for the first and second capacitors C₁, C₂, 208, 209, and the current curve I_{L} of the current flowing through the coil L as a result of the above-mentioned functionality of the electromagnetic transmitter unit 203.

As can be seen in the figure, some energy is lost at each transport of charge from one side to the other. The resulting voltage over the second capacitor C₂ is a little smaller than the previous voltage over the first capacitor C₁ and the second current pulse is also smaller than the first current pulse in a time period tp of the current flow I_{L} i.e. some energy is lost at each transport of charge as mentioned above. The loss of energy may suggest that the time period tp ends with a recharge of the first capacitor C₁ from the energy source ES (not illustrated).

The main contributions to the energy loss are resistance in the coil L and forward voltage on the diode D.

In low voltage applications, such as battery operated flow meter supposed to operate for many years—especially water flow meters—it is advantageous to optimize the circuit even more, so that energy is conserved and the smaller batteries can be used, longer operational lifetime can be obtained or more frequent measurements can be made.

The resistance in the coil L can be lowered by using thicker wire, with implication to the final size of the coil and thus the flow meter itself in addition to added cost of the coil.

The forward voltage of the diode D becomes the main critical loss factor in low power applications, and a way to improve it is to use a low forward voltage diode such as a Schottky diode (as already implied in FIGS. 5A and 6A). The general technical characteristic and functionality of a Schottky diode is well-known by the skilled person.

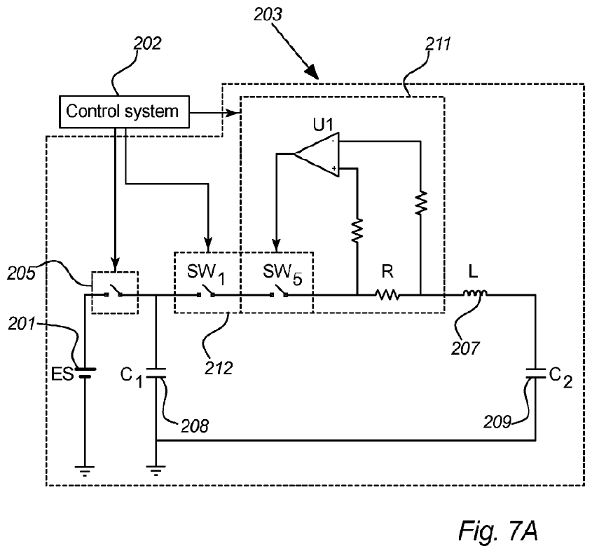

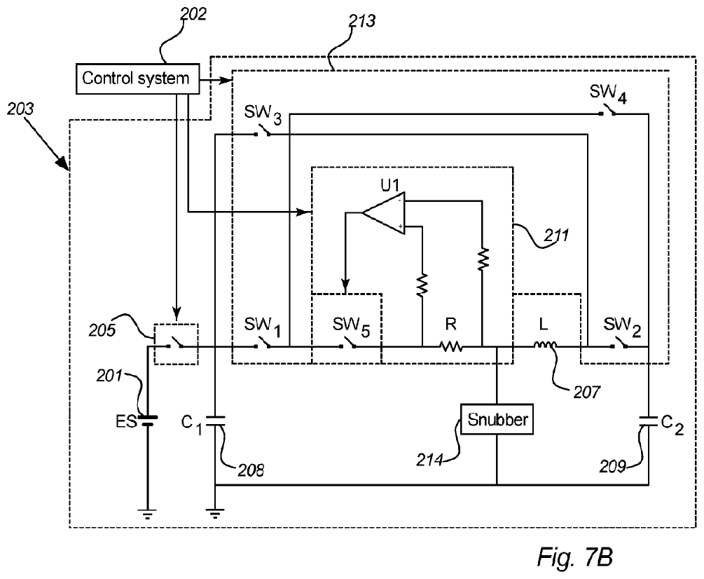

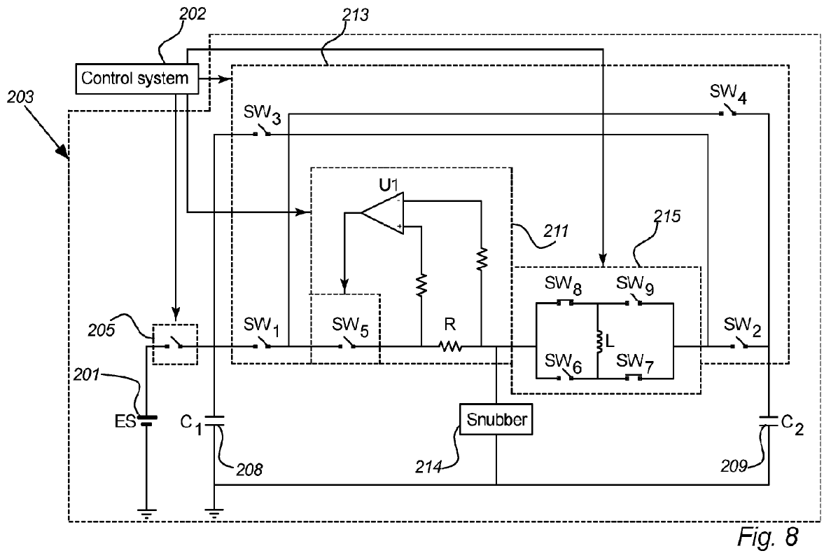

FIG. 7A illustrates the first aspects of a further embodiment of an electromagnetic transmitter unit 203 of an electromagnetic flow meter 200 according to the invention.

To improve, a more sophisticated approach is advantageous. In the figure is depicted a circuit similar to the one in FIG. 5A but the diode D is replaced in the reduced switching arrangement 211, 212 by a small diode circuit comprising a resistor R and a comparator U1 as well as input resistors and connections to the energy source.

The resistor R is used for measuring the current through the at least one magnetic field coil L. The voltage over R drives the differential input voltage on the input of the comparator U1, so that the voltage controlled switch SW₅ is closed as long as the current going onto the coil is positive. When the current becomes negative, then the output of the comparator changes and the switch opens—thus effectively stopping the current from flowing. In other words, the diode circuit operates as a diode that prevents current from flowing in the direction right to left in the at least one magnetic field coil L.

Such a diode circuit (known as an ideal diode circuit by the skilled person) can be implemented in many ways, but typically it can be implemented with a much lower forward loss than a Schottky diode. In some implementations, it is the small voltage across the switch SW₅ itself that is used to measure the current in the ideal diode—thus decreasing the loss even further by eliminating the loss in the resistor R (by eliminating the resistor).

FIG. 7B illustrates another embodiment of an electromagnetic transmitter unit 203 of an electromagnetic flow meter 200 according to the invention.

The embodiment uses the circuit illustrated in FIG. 7A with a full switching arrangement 213 comprising the switches SW₁ to SW₄ with a functionality as already explained in connection with FIG. 6A.

The circuit of the embodiment also comprises a snubber circuit 214 added to prevent very brief kickback voltage spikes from the switching of the at least one magnetic field coil L. The kickback voltages may damage the switches and other parts of the circuit as well as be a source of electromagnetic interference EMI.

The snubber provides a short-term alternative current path away from the switching arrangement so that the mentioned voltage spikes may be discharged more safely. The excessive energy in the coil at the switching time for the switches is then coupled to ground or a capacitor in the snubber circuit depending on the polarity of the voltage.

FIG. 8 illustrates an even further embodiment of an electromagnetic transmitter unit of an electromagnetic flow meter according to the invention.

The circuit of the embodiment includes four more switches SW₆ to SW₉ in an H-bridge structure or configuration around the at least one magnetic field coil L. This advanced coil and switch structure allows the direction of the current in the coil L to be changed between measurements by the pickup electrodes in the detector unit (not shown in the figure).

The benefit of this is that the resulting magnetic field from the coil L will reverse and thus the measured induced voltage between the electrodes in the detector unit of the electromagnetic flow meter. This means that the offset (energy loss) in the small measured voltage between the pickup electrodes in the detector unit can be eliminated by subtracting two successive measurements obtained by opposing magnetic fields. The offset in the small measured voltage may typically be in a nanovolt range when the offset is not a result of a fraudulent behavior against the functionality of the flow meter by applying external magnetic fields.

The switches SW₆ to SW₉ in the H-bridge may be operated to provide a resulting magnetic field from the coil L that will be reversed several times per second in a symmetric or asymmetric operational pattern (e.g. in relation to the operational pattern of the switches SW₁ to SW₄ and the switch SW₅ in the ideal diode circuit).

It is noted, that various components and considerations described for the various embodiments of electromagnetic transmitter units above, for example with reference to FIGS. 3A-3B, 4A-4B, 5A-5B, 6A-6B, 7A, 7B or 8, may be combined, exchanged, optimized, etc. as described, as will be acknowledged by the skilled person. For example may the snubber circuit of FIGS. 7B and 8 be applied to any of the transmitter unit embodiment with similar results and consideration, the H-bridge way of reversing polarity in FIG. 8 may be applied to any of the embodiments, the ‘ideal diode’ circuit may be applied to any of the embodiments, or replaced with for example the Schottky diode of FIGS. 5A or 6A, the component value examples described with reference to FIG. 5A may provide a good starting point for finding suitable components for the other embodiments if not being ideal as is, the considerations about loss and decreasing capacitor voltage and current with each current pulse, and recharging consideration apply to all the embodiments, etc., as acknowledgeable by the skilled person based on the example embodiments described herein.

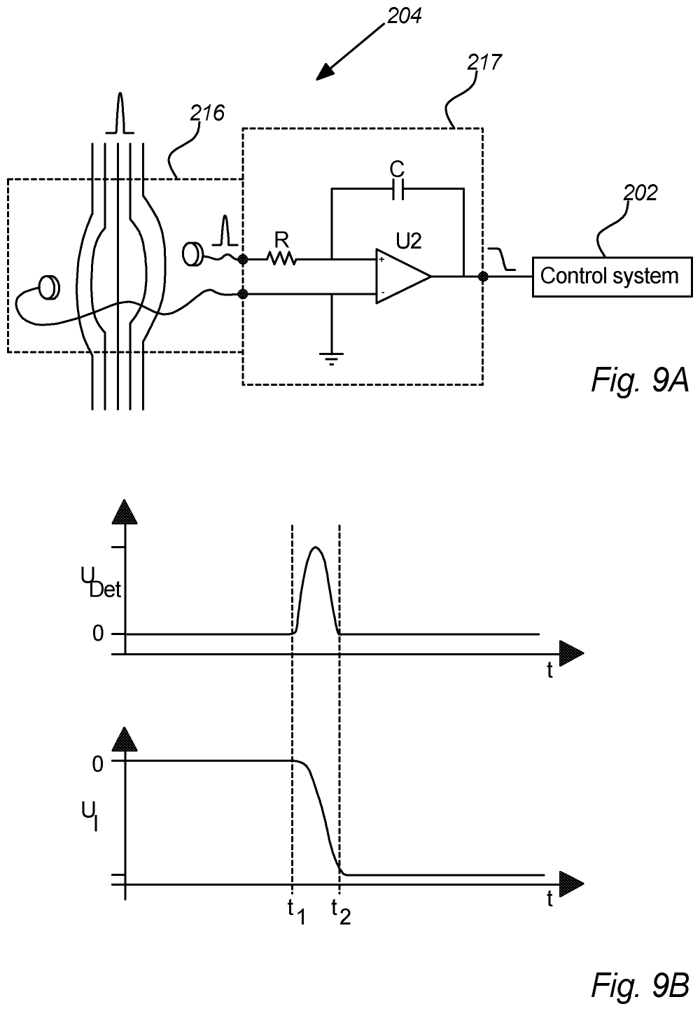

FIG. 9A illustrates an embodiment of a detector unit 204 for an electromagnetic flow meter according to the invention.

The electric components of the detector unit 204 include a voltage detector with two pickup electrodes 216. The induced voltage U_{Det} of the pickup electrodes are measured as a result of the magnetic field transmitted by a magnetic field coil L in the detector unit via the flowing conductive fluid (not illustrated in the figure).

The electric components also include an electronic integrator 217 for integrating the different sized/non-constant pulses of induced voltage U_{Det} within a time period (tp). The electronic integrator of the illustrated embodiment is an analogue integrator using an operational amplifier U2 as the central part in the well-known integrating amplifier circuit.

The output signal of the electronic integrator is the time integral of its input signal i.e. the induced voltage U_{Det} when the value is larger than zero voltage. The integrator accumulates the input quantity over a defined time to produce a representative output sum for the control system 202.

The detected, induced voltage may, as is, as integrated, as sampled, as integrated and sampled in either order, be used to determine an indication of the flow velocity in the flow tube, and thereby of the flow volume by multiplying the with tube cross section area. The evaluation may for example be performed by the control system or by an evaluation arrangement of the detector unit.

In a preferred embodiment, a representation of the established magnetic field, e.g. in terms of a sampled, integrated magnetic coil current, as well as a representation of the induced voltage, e.g. in terms of a sampled, integrated electrode voltage, are used as input to the evaluation arrangement, to evaluate the induced voltage in the light of the value of the actually transmitted current pulse. This is advantageous, as the current pulses and thereby the magnetic fields are continuously changing because of sequential losses and recurrent recharging.

FIG. 9B illustrates a curve of the induced voltage U_{Det} as detected by the pickup electrodes 216 in the detector unit 204. The detected voltage U_{Det} is shown as one pulse in a series of different sized/non-constant pulses within a time period tp (corresponding to time period tp described above with reference to FIG. 6B; not shown in FIG. 9B).

The figure also illustrates an example resulting voltage U₁ from the time integration by the electronic integrator 217 of the detected voltage U_{Det}, where circuit design has caused the resulting sign to be reversed, however numerically corresponding to the integrated U_{Det}.

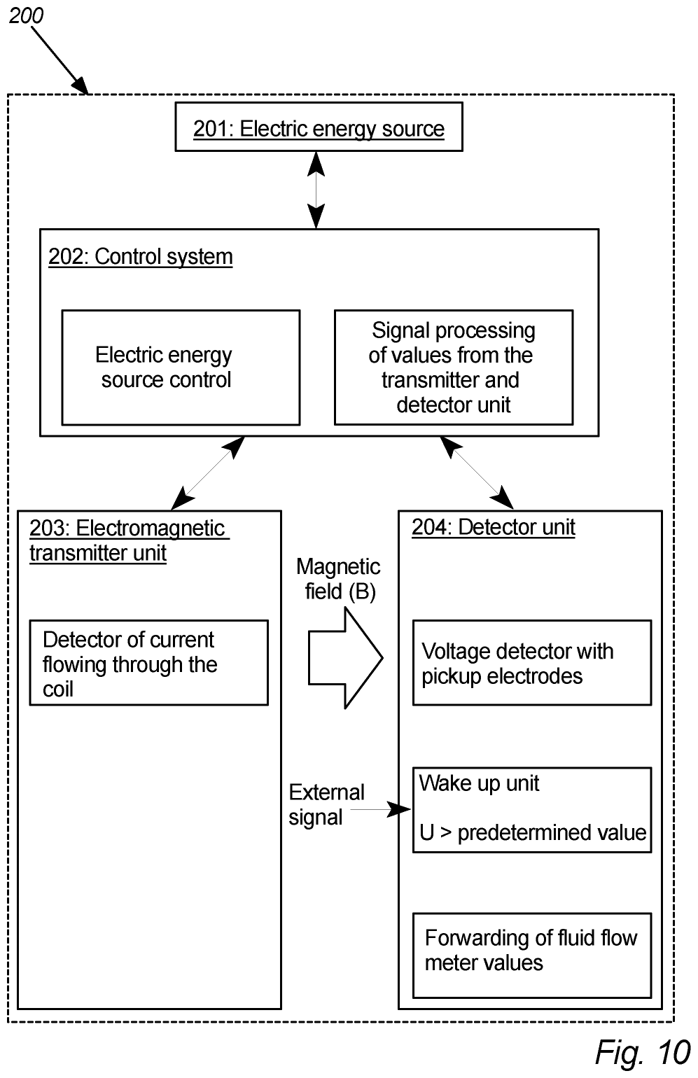

FIG. 10 illustrates aspects of an embodiment of the electromagnetic flow meter 200 according to the invention.

The illustrated aspects in different parts of the flow meter 200 may include:
Control of energy consumption from the electric energy source 201 by the control system 202 in the flow meter 200. The control system 202 may control sleep and wake up modes for the electromagnetic transmitter unit 203 and detector unit 204 ensuring that the units do not use unnecessary power in non-transmission and detecting periods. The control system 202 may provide the electromagnetic transmitter unit 203 with sleep and wake-up signals for a period between one magnetic pulse and the next from the coil L if the pulses are significantly spaced apart. Further, the control system may provide a wake-up signal to the detector unit 204 when the electromagnetic transmitter unit 203 is initiating the transmission of a magnetic pulse from the coil L by operating the switching arrangement in the transmitter unit.
Control of signal processing in the electromagnetic transmitter unit 203 and detector unit 204 including digital sampling of the induced voltage U that the pickup electrodes generate when detecting the magnetic field B introduced in the fluid flow by the coil L in the electromagnetic transmitter unit 203. The sample rate of the induced voltage is preferably at least 250 kSPS (thousands of samples per second).
Detecting an indication of the size of the created magnetic field as non-constant pulses transmitted by the coil L in the transmitter unit 203 e.g. by measuring the current flowing through the coil L. The current measurement may be of the total current through coil wherein this could be either sampled values during the current pulse or by integrating a signal related to the current and then sampling the resulting integrated value.
Detecting the induced voltage in the detector unit 204 in response to a transmitted magnetic field pulse e.g. by using a voltage detector with pickup electrodes. The detection of the induced voltage can be realized by integrating a signal related to the voltage from the electrodes over one pulse or a number of pulses instead of sampling the instantaneous values.
The signal values of the detected magnetic field (B) and induced voltage (U) are forwarded to the control system 202 for establishing fluid flow meter values (V) using Faraday's law.

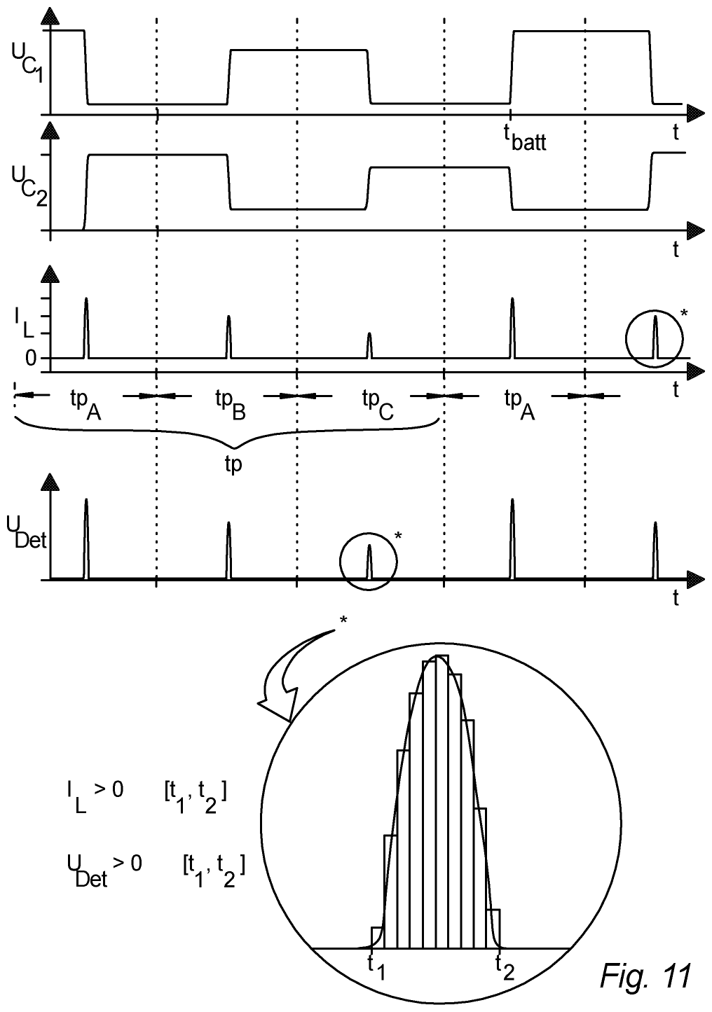

FIG. 11 illustrates an example of the relationship between voltage and current values in the electromagnetic transmitter unit 203 and detector unit 204 of the electromagnetic flow meter 200 according to the invention.

The first two curves illustrate the voltage U_{C1}, U_{C2} over the first and second capacitors C₁, C₂ in the embodiments of in the electromagnetic transmitter unit 203 e.g. as disclosed above in connection with e.g. FIGS. 6A, 7B and 8. The switching arrangement in the transmitter unit effects a change of energy from the first capacitor C₁ through the magnetic field coil to the second capacitor C₂ whereby the voltage U_{C1} drops to a low value and the voltage U_{C2} is raised from a low value to a high value before the voltage process is reversed to a high voltage U_{C1} and a low voltage U_{C2} when operation of the switching arrangement effects a new change.

Further, the first curve illustrates a situation at time t_{Batt} wherein the voltage U_{C1} for the first capacitor C₁ has dropped to a predetermined limit value. The control system allows the electric energy source ES to recharge the first capacitor C₁ to a fixed voltage e.g. a high value corresponding to the voltage of the energy source before disconnect the electric energy source again.

The third curve illustrates the current I_{L} flowing through the magnetic field coil L as a series of current pulse with decreasing current, i.e. different sized/non-constant pulses within a time period tp. The time period tp is defined as the current pulses between two recharge operations by the electric energy source of the first capacitor C₁.

The illustrated example has four current pulses A, B, C, D in the four sub-periods tp_{A}, tp_{B}, tp_{C}, tp_{D} of the full time period tp wherein the pulses successively become smaller over the time period before another recharge of first capacitor C₁ is initiated. It shall be emphasised that the number of current pulses in a time period is only defined by the voltage of the first capacitor C₁, the losses experienced for each pulse, and especially the predetermined limit value initiating another recharge operation.

The curve also illustrates that the current I_{L} flowing through the magnetic field coil L is disconnected at zero current e.g. by a circuit comprising a diode D or an ideal diode circuit as disclosed above.

The fourth curve illustrates the induced voltage U_{Det} in the detector unit 204 as a result of the series of decreasing current pulses within a time period tp through the magnetic field coil L and the fluid flow through the flow meter 200.

The measurement of the current I_{L} flowing through the magnetic field coil L and/or the detection of the induced voltage can be realized by integrating of the digital sampled pulse signals for and by control of the control system i.e. using a digital integrator for establishing a quantity of the series of decreasing current pulses within the time period tp.

At the bottom of FIG. 11, a single current pulse has been illustrated in an enlarged view. It illustrates an integration of the quantity of one pulse of the current I_{L} flowing through the magnetic field coil L from time t₁ to t₂ by use of digital sampling i.e. controlled by the control system to sampling and measurement in the time wherein the current I_{L} (I_{L} being directly linked to the size of the transmitted magnetic field B by at least one magnetic field coil in the transmitter unit) is larger than zero current. Consequently, the sampling and measurement may be restricted to the time of the pulse instead of continuous sampling and measurement of the instantaneous values.

The enlarged view in the bottom of FIG. 11 may also illustrate one pulse of the induced voltage U_{Det} from the pickup electrodes of the voltage detector in the detector unit 204. It then illustrates an example of the sampling and measurement of the voltage pulse from time t₁ to t₂ i.e. controlled by the control system to sampling and measurement in the time wherein the induced voltage U_{Det} is larger than zero voltage. Consequently, the sampling and measurement may be restricted to the time of the pulse instead of continuous sampling and measurement of the instantaneous values.

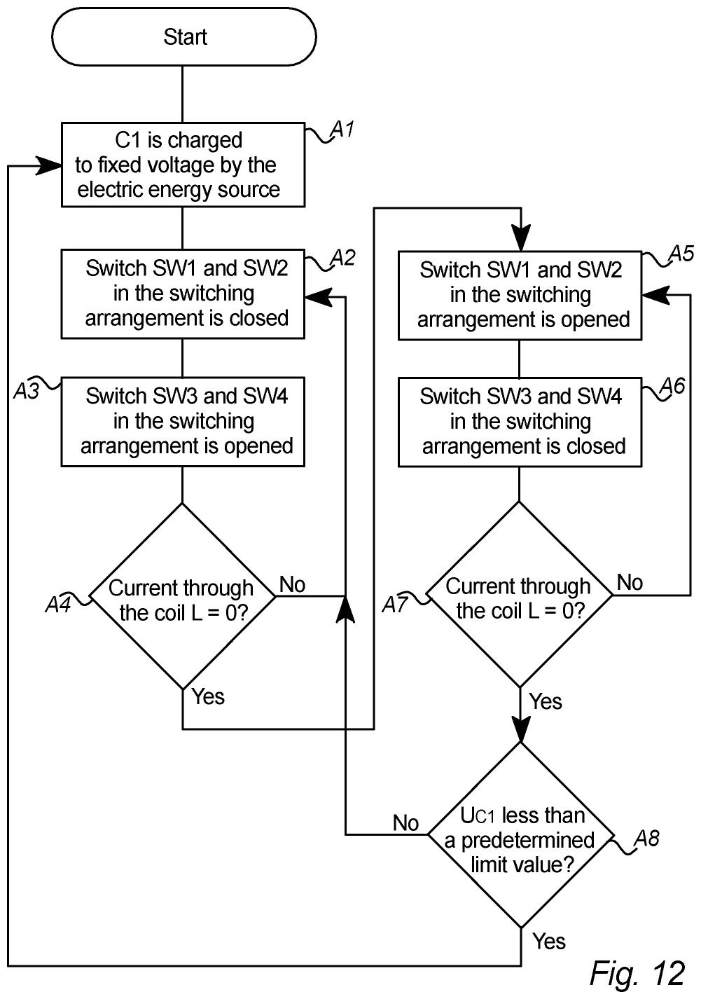

FIG. 12 illustrates a flow diagram for the functionality of the electromagnetic transmitter unit 203 in the electromagnetic flow meter 200 according to the invention.

The steps in the flow diagram may for example be used in the embodiments of the electromagnetic transmitter unit 203 in FIGS. 6A, 7B and 8.

Steps:
(A1) The first capacitor C₁ is charged to a fixed voltage by the electric energy source and the second capacitor C₂ is practically uncharged i.e. the voltage over C₁ is initially high and the voltage over C₂ is
(A2-A3) The switches SW₁ and SW₂ in the switching arrangement are closed and the switches SW₃ and SW₄ opened in order for the current to start flowing through the magnetic field coil L from the first capacitor C₁ towards the second capacitor C₂.
(A4) The current reaches zero after some time when charge of the first capacitor C₁ has been moved to the second capacitor C₂.
(A5-A6) The switches SW₃ and SW₄ in the switching arrangement are closed after the switches SW₁ and SW₂ have been opened in order for the current to start flowing through the magnetic field coil L from the second capacitor C₂ towards the first capacitor C₁.
(A7) The current reaches zero after some time when charge of the second capacitor C₂ has been moved to the first capacitor C₁.
(A8) The electric energy source is connected to the first capacitor C₁ if the voltage over the first capacitor C₁ is measured to be below a predetermined limit value i.e. a charging operation as disclosed in step A1.

The switches SW₃ and SW₄ in the switching arrangement are opened and the switches SW₁ and SW₂ are closed in order for the current to start flowing through the magnetic field coil L from the first capacitor C₁ towards the second capacitor C₂ if the voltage over the first capacitor C₁ is measured to be above the predetermined limit value or if the charging operation has been completed i.e. as disclosed in steps A2 and A3 in the continuous proceeding through the steps.

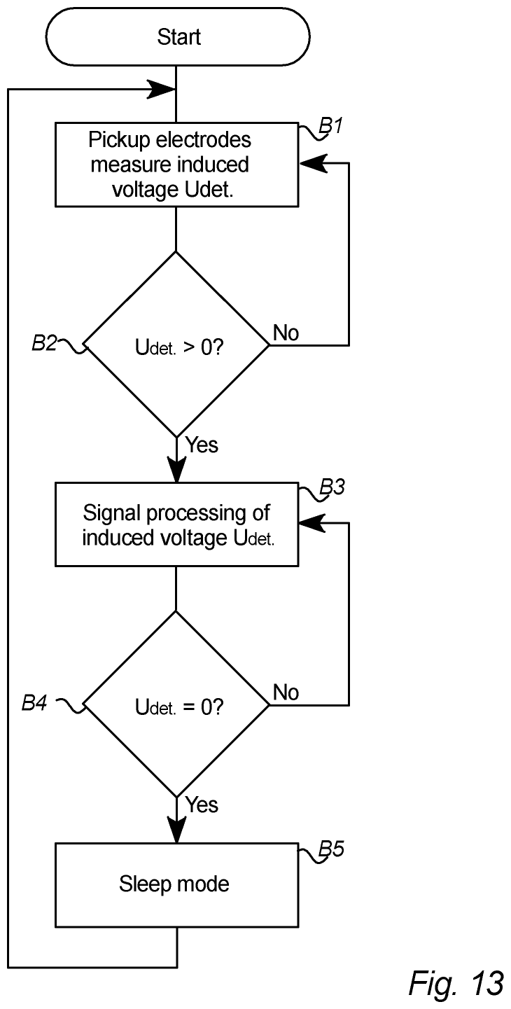

FIG. 13 illustrates a flow diagram for the functionality of the detector unit 204 in the electromagnetic flow meter 200 according to the invention.

The steps in the flow diagram may for example be used in the embodiments of the detector unit 204 illustrated in FIGS. 9A, 9B and 10.

Steps:
(B1-B2) An induced voltage U_{Det} is detected by a voltage detector with pickup electrodes in the detector unit 204 if a magnetic field has been transmitted to the flowing fluid by the electromagnetic transmitter unit 203. Otherwise, the detector unit 204 is placed in a sleep mode for conserving electric energy.
(B3) An induced voltage U_{Det} above zero is detected and a signal process is initiated e.g. by sampling and measuring the induced voltage as one pulse or as the sum of series of smaller and smaller pulses within a time period tp as result of the current flowing through the magnetic field coil L. The induced voltage is a representation of the flow rate of a conductive fluid flowing through the flow meter.
(B4-B5) The detector unit 204 is placed in a sleep mode for conserving electric energy when the induced voltage U_{Dec} is detected to be zero again.

In the above description, various embodiments of the invention have been described with reference to the drawings, but it is apparent for a person skilled within the art that the invention can be carried out in an infinite number of ways, using e.g. the examples disclosed in the description in various combinations, and within a wide range of variations within the scope of the appended claims.

### LIST OF REFERENCE SIGNS

100 Electromagnetic flow meter

101 Pipe or tube wherein a fluid flows; flow tube

102 Coil or coils for creating a magnetic field

103 Energy supply for magnetic field coils

104 Pickup electrodes for an induced voltage

105 Induced voltage measuring unit

200 Electromagnetic flow meter according to the invention

201 Electric energy source for the electromagnetic flow meter such as one or more electric batteries

202 Control system for the electromagnetic flow meter

203 Electromagnetic transmitter unit

204 Detector unit

205 Recharge switch for operating the recurring energization by the electric energy source of the capacitive energy storage

206 Switching arrangement for arranging the energy flow through the magnetic field coil

207 At least one magnetic field coil L for creating a magnetic field in a fluid flow

208 First capacitor C₁

209 Second capacitor C₂

210 Switching arrangement for arranging the energy flow through the magnetic field coil

211 Ideal diode in a switching arrangement

212 First switch SW₁ in a switching arrangement

213 Switching arrangement including an ideal diode circuit for arranging the energy flow through the magnetic field coil

214 Snubber circuit

215 Switches SW₅ to SW₉ in a switching arrangement for bridging the energy flow through the at least one magnetic field coil

216 Pickup electrodes for an induced voltage

217 Integrator circuit in the detector unit

218 Capacitive energy storage

A₁ to A₈ Steps in a first flow diagram of an embodiment of the electromagnetic transmitter unit

B₁ to B₅ Steps in a second flow diagram of an embodiment of the detector unit

C₁, C₂ First and second capacitors 208, 209

D Diode, preferably a Schottky diode

EF Energy flow

ERF Energy reflow

ES Electric energy source for the electromagnetic flow meter such as one or more electric batteries

I_{L} Current through the at least one magnetic field coil

L At least one magnetic field coil 207 for creating a magnetic field in a fluid flow

R Resistor for measuring the current through the at least one magnetic field coil

SW Switch for arranging or bridging the energy flow through the at least one magnetic field coil

t Time

tp Time period

tp_{A} to tp_{C}. Parts of a time period comprising a single pulse current through the at least one magnetic field coil

U_{C1}, U_{C2} Voltage over the first and second capacitors

U_{Det} Induced voltage detected over the pickup electrodes of the detector unit

1. An electromagnetic transmitter unit for an electromagnetic flow meter arranged to measure a flow rate of a conductive fluid flowing through the flow meter, said transmitter unit comprises:
a capacitive energy storage comprising at least one capacitor,
a magnetic field coil, and
a switching arrangement;
wherein the switching arrangement is configured for effecting a first energy flow from the capacitive energy storage to the magnetic field coil and a first energy reflow from the magnetic field coil to the capacitive energy storage for generation of a first current pulse for transmitting a magnetic field to the conductive fluid.

2. The electromagnetic transmitter unit according to claim 1, wherein the switching arrangement is further configured for effecting a second energy flow and a second energy reflow between the capacitive energy storage and the magnetic field coil for generation of a second current pulse for transmitting a magnetic field to the conductive fluid.

3. The electromagnetic transmitter unit according to claim 2, wherein the current of the second current pulse is smaller than the current of the first current pulse.

4. The electromagnetic transmitter unit according to claim 2, wherein the second energy flow and second energy reflow is more than 80% of the first energy flow and first energy reflow.

5. The electromagnetic transmitter unit according to claim 1, wherein the capacitive energy storage comprises a first capacitor, and wherein the switching arrangement is configured for effecting the first energy flow from the first capacitor to the magnetic field coil and the first energy reflow from the magnetic field coil to the first capacitor.

6. The electromagnetic transmitter unit according to claim 1, wherein the capacitive energy storage comprises a first capacitor and a second capacitor, and wherein the switching arrangement is configured for effecting the first energy flow from the first capacitor to the magnetic field coil and the first energy reflow from the magnetic field coil to the second capacitor.

7. The electromagnetic transmitter unit according to claim 6, wherein the switching arrangement is configured for effecting the second energy flow from the second capacitor to the magnetic field coil and the second energy reflow from the magnetic field coil to the first capacitor.

8. (canceled)

9. The electromagnetic transmitter unit according to claim 1, wherein the magnetic field coil is voltage driven by the capacitive energy storage.

10. The electromagnetic transmitter unit according to claim 1, wherein the first current pulse is a first time-dependent current pulse.

11. The electromagnetic transmitter unit according to claim 1, wherein the transmitter unit further comprises an energy source and a recharge switch for recurring energization of the capacitive energy storage.

12. The electromagnetic transmitter unit according to claim 11, wherein the energization of the capacitive energy storage comprises a charging of the first capacitor from the energy source.

13. The electromagnetic transmitter unit according to claim 11, wherein the energy source comprises a battery.

14. (canceled)

15. The electromagnetic transmitter unit according to claim 1, wherein the switching arrangement is further configured for terminating the first energy flow from the capacitive energy storage when the current of the first current pulse is zero.

16. The electromagnetic transmitter unit according to claim 1, wherein the transmitter unit is arranged to establish a digital representation of the first current pulse for signal processing.

17-107. (canceled)

108. An electromagnetic flow meter arranged to measure a flow rate of a conductive fluid flowing through the flow meter, said flow meter comprises:
an electromagnetic transmitter unit comprising a capacitive energy storage comprising at least one capacitor, a magnetic field coil, and a switching arrangement; wherein the switching arrangement is configured for effecting a first energy flow from the capacitive energy storage to the magnetic field coil and a first energy reflow from the magnetic field coil to the capacitive energy storage for generation of a first current pulse for transmitting a magnetic field to the conductive fluid,
a detector unit for measuring an induced voltage signal induced by the magnetic field, and
a control system for controlling the operation of the electromagnetic transmitter unit and the detector unit in establishing a value of the fluid flow rate.

109-115. (canceled)

116. A method for measuring a flow rate of a conductive fluid flowing through an electromagnetic flow meter including an electromagnetic transmitter unit (203), a detector unit, and a control system, the method comprising the steps of:
effecting with a switching arrangement operated by the control system a first energy flow from a capacitive energy storage of the transmitter unit to the magnetic field coil of the transmitter unit and a first energy reflow from the magnetic field coil to the capacitive energy storage for generation of a first current pulse for transmitting a magnetic field to the conductive fluid,
measuring an induced voltage signal induced by the transmitted magnetic field via the conductive fluid with a voltage detector in the detector unit, and
determining the flow rate of the conductive fluid from the energy flow and the induced voltage signal.

117. The method of claim 116, comprising a further step of:
effecting with the switching arrangement a second energy flow and a second energy reflow between the capacitive energy storage and the magnetic field coil for generation of a second current pulse for transmitting a magnetic field to the conductive fluid.

118. The method of claim 117, comprising generating the second current pulse with a smaller current than the generated first current pulse.

119-122. (canceled)

123. The method according to claim 116, further comprising a step of recurrently energizing the capacitive energy storage from an energy source, preferably a battery.

124. (canceled).

125. The method according to claim 116, comprising terminating the first energy flow from the capacitive energy storage when the current of the first current pulse is zero.

126. (canceled)
